(19) United States
(12) Patent Application Publication
(10) Pub. No.: US 2023/0343359 A1
(43) Pub. Date: Oct. 26, 2023

(54) LIVE SPEECH DETECTION

(71) Applicant: Cirrus Logic International Semiconductor Ltd., Edinburgh (GB)

(72) Inventors: William E. SHERWOOD, Salt Lake City, UT (US); Fred D. GEIGER, Sandy, UT (US); Narayan KOVVALI, Tempe, AZ (US); Seth SUPPAPPOLA, Tempe, AZ (US)

(73) Assignee: Cirrus Logic International Semiconductor Ltd., Edinburgh (GB)

(21) Appl. No.: 17/729,238

(22) Filed: Apr. 26, 2022

(51) Int. Cl. G10L 21/0388; G10L 15/20; G10L 21/0364

(52) U.S. Cl. CPC G10L 21/0388; G10L 15/20; G10L 21/0364

(57) ABSTRACT

A method of detecting a suitability of a signal for live speech detection, the method comprising: receiving the signal containing speech from a transducer; measuring a signal characteristic of an audible component of the received signal; estimating an expected signal characteristic of an ultrasonic component of the received signal based on the measured signal characteristic of the audible component; determining, based on the estimated expected signal characteristic, whether the ultrasonic component is suitable for detecting whether the speech is live speech.

### TECHNICAL FIELD

The present disclosure relates to methods of and apparatus for determining the suitability of audio signals for ultrasonic live speech detection.

### BACKGROUND

Known speech recognition system allow a user to control a device or system using spoken commands. It is common to use speaker recognition systems in conjunction with speech recognition systems. A speaker recognition system can be used to verify the identity of a person who is speaking, and this can be used to control the operation of the speech recognition system.

An issue with speech recognition systems is that they can be activated by speech that was not intended as a command. For example, speech from TV or radio loudspeaker might be incorrectly determined by a speech recognition system to be live speech from a user, which may in turn cause one or more unintended actions to be performed.

Methods exists for delineating between audio signals containing live speech (e.g. speech provided directly to a transducer from a user's mouth) and replayed speech (e.g. speech provided to a transducer from a loudspeaker). On such method involves looking at ultrasonic content in the audio signal received at the transducer.

### SUMMARY

According to a first aspect of the disclosure, there is provided a method of detecting a suitability of a signal for live speech detection, the method comprising: receiving the signal containing speech from a transducer; measuring a signal characteristic of an audible component of the received signal; estimating an expected signal characteristic of an ultrasonic component of the received signal based on the measured signal characteristic of the audible component; determining, based on the estimated expected signal characteristic, whether the ultrasonic component is suitable for detecting whether the speech is live speech.

The measured signal characteristic and the expected signal characteristic may the same signal characteristic. Each characteristic may be a power level, or and a sound pressure level.

The method may further comprise, on determining that the ultrasonic component is suitable, determining that the speech is live speech based on the ultrasonic component.

Determining that the speech is live speech may comprise: measuring a signal characteristic in the ultrasonic component of the received signal; and determining whether the speech is live speech based on the measured signal characteristic.

The measured signal characteristic in the ultrasonic component may comprise a power level or a sound pressure level.

The method may further comprise determining whether the received signal comprises speech.

Determining whether the ultrasonic component is suitable for detecting whether the speech is live speech may comprise comparing the expected signal characteristic to an ultrasonic signal characteristic threshold.

Measuring the signal characteristic of the audible component may comprise: bandpass filtering the received audio signal to generate one or more bandpass filtered audio signals; and measuring the signal characteristic in one or more of the one or more bandpass filtered audio signals.

The one or more bandpass filtered audio signals may comprise two or more bandpass filtered signals. In which case, measuring the signal characteristic of the audible component may further comprises applying weights to the measured signal characteristics in the two or more bandpass filtered signals. The estimation of the expected signal characteristic in the ultrasonic component may then be based on one or more weighted bandpass filtered signals.

The weights may be applied to emphasize one or more of the bandpass filtered signals that correspond to human loudness perception.

Weights may be applied to reduce sensitivity to differences in speech between different cohorts of the population, such as between adults and children, or between adult males and adult females.

Estimating the expected signal characteristic may comprise providing the measured signal characteristic to a model of the expected signal characteristic for live speech. The model of the expected signal characteristic for live speech may be generated using a speech model for a user of the transducer. The model of the expected signal characteristic for live speech may be generated using a cohort of speakers.

The model may be generated using (optionally recurrent) neural network prediction. For example, a neural network may be trained with inputs relating to user' voice and/or the voice of the cohort of speakers. The trained neural network may then be used to predict the expected signal characteristic based on the measured signal characteristics. Implementations of neural networks are known in the art and so will not be described in detail here.

According to another aspect of the disclosure, there is provided a non-transitory storage medium having instructions thereon which, when executed by a processor, cause the processor to perform the method described above.

According to another aspect of the disclosure, there is provided an apparatus for detecting a suitability of a signal for live speech detection, the method comprising: an input for receiving a signal containing speech from a transducer; one or more processors configured to: measure a signal characteristic of an audible component of the received signal; estimate an expected signal characteristic of an ultrasonic component of the received signal based on the measured signal characteristic of the audible component; determine, based on the estimated expected signal characteristic, whether the ultrasonic component is suitable for detecting whether the speech is live speech.

The measured signal characteristic and the expected signal characteristic may be the same signal characteristic. Such characteristics may comprise one of power and sound pressure.

The one or more processors may be configured to: on determining that the ultrasonic component is suitable, determine that the speech is live speech based on the ultrasonic component.

The one or more processors may be configured to determine whether the ultrasonic component is suitable for detecting whether the speech is live speech by comparing the expected signal characteristic to an ultrasonic signal characteristic threshold.

According to another aspect of the disclosure, there is provided an electronic device comprising the apparatus described above.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 illustrates an audio device;

FIG. 2 is a schematic diagram of the audio device of FIG. 1;

FIG. 3 illustrates a situation in which a replay attack is being performed;

FIGS. 4A and 4B are comparative frequency spectrums for live and replayed speech at a relatively high signal level;

FIGS. 5A and 4B are comparative frequency spectrums for live and replayed speech at a relatively low signal level;

FIG. 6 is a block diagram illustrating a suitability detection module according to embodiments of the disclosure; and

FIG. 7 is a block diagram of the suitability detection module of FIG. 6 in combination with a liveness detection module.

### DESCRIPTION OF EMBODIMENTS

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

The methods described herein can be implemented in a wide range of devices and systems, for example a mobile telephone, an audio player, a video player, a mobile computing platform, a games device, a remote controller device, a toy, a machine, or a home automation controller or a domestic appliance. However, for ease of explanation of one embodiment, an illustrative example will be described, in which the implementation occurs in a smartphone.

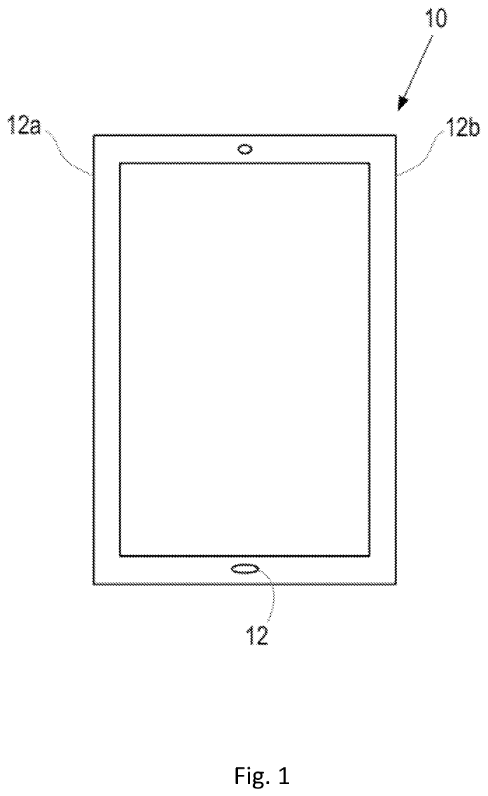

FIG. 1 illustrates an audio device 10, such as a smartphone, having a microphone 12 for detecting ambient sounds. In normal use, the microphone is of course used for detecting the speech of a user who is holding the device 10 close to their face.

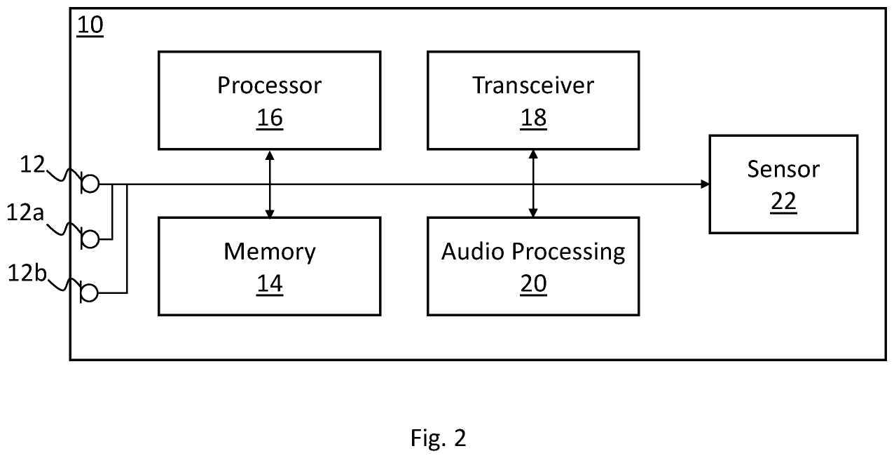

FIG. 2 is a schematic diagram, illustrating the form of the device 10.

Specifically, FIG. 2 shows various interconnected components of the device 10. It will be appreciated that the device 10 will in practice contain many other components, but the following description is sufficient for an understanding of the present invention.

Thus, FIG. 2 shows the microphone 12 mentioned above. In certain embodiments, the device 10 is provided with multiple microphones 12, 12a, 12b, etc.

FIG. 2 also shows a memory 14, which may in practice be provided as a single component or as multiple components. The memory 14 is provided for storing data and program instructions.

FIG. 2 also shows a processor 16, which again may in practice be provided as a single component or as multiple components. For example, one component of the processor 16 may be an applications processor of the device 10.

FIG. 2 also shows a transceiver 18, which is provided for allowing the device 10 to communicate with external networks. For example, the transceiver 18 may include circuitry for establishing an internet connection either over a Wi-Fi local area network or over a cellular network.

FIG. 2 also shows audio processing circuitry 20, for performing operations on the audio signals detected by the microphone 12 as required. For example, the audio processing circuitry 20 may filter the audio signals or perform other signal processing operations.

In this embodiment, the device 10 is provided with voice biometric functionality, and with control functionality. Thus, the device 10 is able to perform various functions in response to spoken commands from an enrolled user. The biometric functionality is able to distinguish between spoken commands from the enrolled user, and the same commands when spoken by a different person. Thus, certain embodiments of the invention relate to operation of a smartphone or another portable electronic device with some sort of voice operability, for example a tablet or laptop computer, a games console, a home control system, a home entertainment system, an in-vehicle entertainment system, a domestic appliance, or the like, in which the voice biometric functionality is performed in the device that is intended to carry out the spoken command. Certain other embodiments relate to systems in which the voice biometric functionality is performed on a smartphone or other device, which then transmits the commands to a separate device if the voice biometric functionality is able to confirm that the speaker was the enrolled user.

In some embodiments, while voice biometric functionality is performed on the device 10 or other device that is located close to the user, the spoken commands are transmitted using the transceiver 18 to a remote speech recognition system (not shown), which determines the meaning of the spoken commands. For example, the speech recognition system may be located on one or more remote server in a cloud computing environment. Signals based on the meaning of the spoken commands are then returned to the device 10 or another local device. In other embodiments, the speech recognition system is also located on the device 10.

One attempt to deceive a voice biometric system is to play a recording of an enrolled user's voice in a so-called replay or spoof attack.

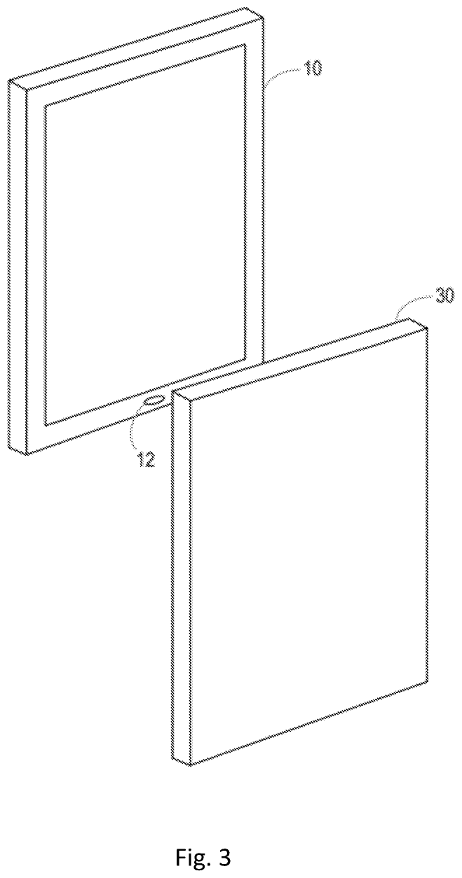

FIG. 3 shows an example of a situation in which a replay attack is being performed. The device 10 is provided with voice biometric functionality. In this example, the device 10 is in the possession, at least temporarily, of an attacker, who has another smartphone 30. The smartphone 30 has been used to record the voice of the enrolled user of the device 10. The smartphone 30 is brought close to the microphone inlet 12 of the device 10, and the recording of the enrolled user's voice is played back. If the voice biometric system is unable to detect that the enrolled user's voice that it detects is a recording, the attacker will gain access to one or more services that are intended to be accessible only by the enrolled user.

This so-called spoofing of a user's voice in voice biometrics is not limited to malicious attacks. For example, if the device 10 is in the vicinity of a device outputting audio via a loudspeaker (e.g. a television (TV), a radio, etc.), playback of human voice via that device may also result in an unintended unlock and/or access of one or more services that are intended to be accessible only be the enrolled user.

In an effort to address this, the device 10 may be configured to determine whether a received signal contains live speech, prior to the execution of a voice biometrics process on the received signal. For example, the device 10 may be configured to confirm that any voice sounds that are detected are live speech, rather than being played back, in an effort to prevent a malicious third party executing a replay attack from gaining access to one or more services that are intended to be accessible only by the enrolled user. In other examples, the device 10 may be further configured to execute a voice biometrics process on a received signal. If the result of the voice biometrics process is negative, e.g. a biometric match is not found, a determination of whether the receive signal contains live speech may not be required.

In the above scenario, a determination of whether the received signal contains live speech is undertaken for the purposes of detecting a malicious replay or spoof attack. However, liveness detection may be equally advantageous in non-malicious scenarios. For example, liveness detection may be implemented to prevent devices with loudspeakers from unintentionally activating voice biometric processes on the device 10 due to speech being played back through such loudspeakers.

In any of the above scenarios, it is advantageous for the device 10 to be able to determine whether the signal received at the microphone represents live speech or speech played back through a loudspeaker. One known method for detecting whether the received signal contains live speech involves determining whether the signal comprises high frequency content. This relies on the observation that human speech comprises ultrasonic frequency content whereas most typical replay devices (e.g. loudspeakers) have poor fidelity at high frequency and therefore output no ultrasonic content in replayed audio. Additionally, it has also been found some acoustic classes of live speech contain more ultrasonic and near-ultrasonic frequency content than other classes. For example, unvoiced classes of speech (e.g. consonants such as fricatives and plosives) contain relatively high levels of ultrasonic and near ultrasonic frequency content, when compared to voiced classes of speech. Replayed speech may therefore be detected by determining whether ultrasonic content is present in the received audio signal, or whether ultrasonic content is below a threshold amount. In contrast, the received audio signal may be deemed to contain live speech if ultrasonic content is present, or if ultrasonic content exceeds a threshold amount.

The inventors have found that in some scenarios, however, an audio signal received at the microphone 12 which contains replayed speech from a loudspeaker may also contain ultrasonic content. Such received audio may be incorrectly deemed to be live speech (false accept). In addition, many signal paths, such as that comprising the microphone 12, there is a lower signal level limit (a noise floor) below which sound received at the microphone 12 is not detectable. The signal level of ultrasonic content in genuine live speech is also typically much lower than that of audible content. This means that a scenario exists in which ultrasonic content of live speech received at the microphone 12 has a signal level which is so low that it falls below the noise floor and can therefore not be detected by the device 10.

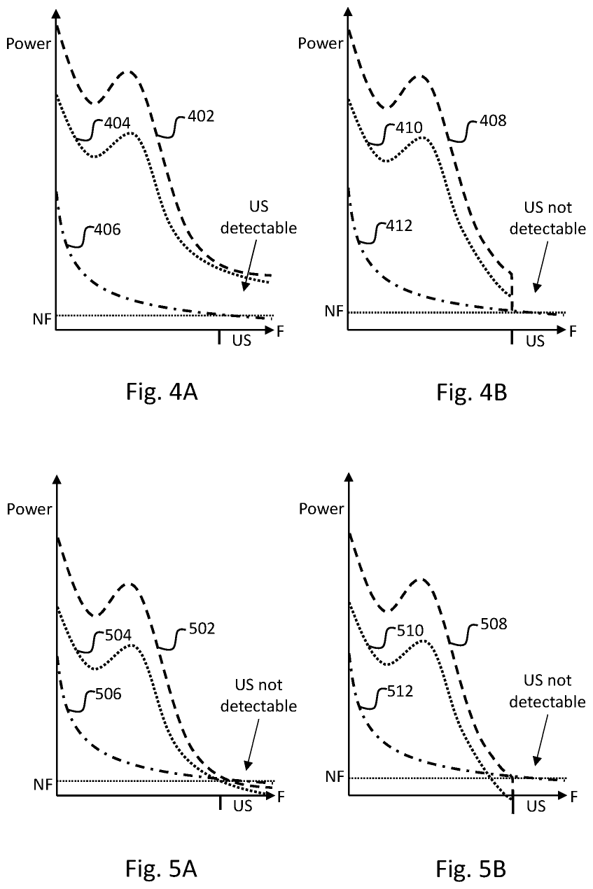

FIGS. 4A, 4B, 5A and 5B graphically illustrate the above issue. FIGS. 4A and 4B each illustrate a frequency spectrum of a received audio signal having a signal power high enough that the signal level of the ultrasonic component of the speech is above a noise floor NF of the signal chain associated with the microphone 12. FIGS. 5A and 5B each illustrate a frequency spectrum of a received audio signal having a signal power so low that the signal level of the ultrasonic component of the speech is below a noise floor NF of the signal chain associated with the microphone 12. Each of FIGS. 4A, 4B, 5A, 5C show a speech component of audio received at the microphone, an environmental noise component of speech received at the microphone 12 and a combined signal made up of the speech and the environmental noise.

Referring to FIG. 4A, a combined frequency spectrum 402 is shown, made up of a live speech component 404 (associated with a user speaking) and an environmental noise component 406. It can be seen that the ultrasonic content of the live speech component 404 present in the signal is above the noise floor NF. As such, the ultrasonic component 404 of speech is detectable in the combined signal 402.

Referring to FIG. 4B, a combined frequency spectrum 408 is shown, made up of a replayed speech component 410 (e.g., associated with speech replayed through a loudspeaker) and an environmental noise component 412. Since the replayed speech component 410 does not contain ultrasonic content (e.g., due to it having been generated by a loudspeaker), in contrast to the live speech component 404 shown in FIG. 4A, ultrasonic content is not detectable in the combined signal 402.

Referring to FIG. 5A, a combined frequency spectrum 502 is shown, made up of a live speech component 504 and an environmental noise component 506. It can be seen that the live speech component 504 has a similar shape to the live speech component 404 shown in FIG. 4A. However, the signal power of the live speech component 504, and therefore the combined frequency spectrum 502, is lower. As such, the ultrasonic component of the combined frequency spectrum 502 is below the noise floor NF of the system associated with the microphone 12.

Referring to FIG. 5B, a combined frequency spectrum 508 is shown, made up of a replayed speech component 510 and an environmental noise component 512. It can be seen that the replayed speech component 510 has a similar shape to the replayed speech component 410 shown in FIG. 4B. However, the signal power of the replayed speech component 510, and therefore the combined frequency spectrum 508, is lower. Regardless, since the replayed speech component 510 does not contain any ultrasonic content and ultrasonic content in the noise component 512 is at a level that sits below the noise floor NF, the signal power of the ultrasonic content in the combined frequency spectrum 508 is also below the noise floor NF.

Thus, comparing FIGS. 5A and 5B, for example, the signal power in the ultrasonic range for the combined live and replayed frequency spectrums 502, 508 are indistinguishable since they both fall below the noise floor NF. In such a scenario, the ultrasonic content of the received audio signal cannot be used to reliable distinguish between live and replayed speech.

Embodiments of the present disclosure aim to address or at least ameliorate one or more of the above issues by making a determination as to whether ultrasonic content of the received audio signal at the microphone 12 can be reliably used for detecting whether speech therein is live or replayed.

Specifically, it has been found that there is a consistent relationship in the power present in the audible band (e.g., between 100 Hz and 20 kHz) and the ultrasonic band (e.g., greater than 15 kHz or 20 kHz) for live speech received at the microphone 12. Ultrasonic sound pressure levels (SPLs) tend to be between approximately 20 dB and approximately 30 dB, for example 27 dB lower than corresponding audible sound pressure levels.

Accordingly, based on a measured audible-band SPL, A, an estimate of the expected ultrasonic SPL, U, can be obtained. This estimated SPL, U, optionally coupled with an estimate of the noise floor associated with the microphone 12 and/or the signal chain associated with the microphone 12, can be used to determine whether the actual ultrasonic component of the received audio signal should have a high enough SPL to be used to detect whether or not the received signal contains live speech. An advantage of this approach is that the signal level or power of the ultrasonic content in the received audio signal need not be measured. Only an audible component of the received audio signal need be analysed to determine whether the received signal is suitable for use in liveness detection using the unmeasured ultrasonic component. Moreover, the received audio need not be segmented into audio classifications such as voiced and unvoiced speech. Such segmentation may be used to increase the amount of expected ultrasonic content (since unvoiced speech tends to include more ultrasonic content). Since in embodiments of the present disclosure only the audible content of the received audio signal need be analysed, audio classification need not be performed. Alternatively, audio classification may be performed after a determination is made as to whether the received audio signal is suitable for ultrasonic analysis.

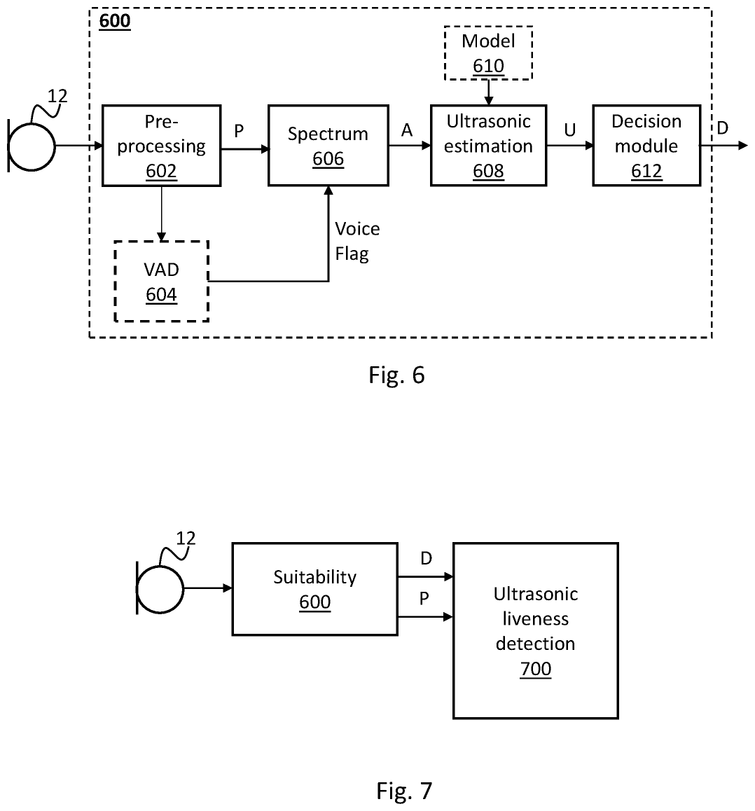

FIG. 6 is a block diagram illustrating the functional modules of a signal suitability module 600 for determining the suitability of a signal for liveness detection.

A microphone 12 (for example one of the microphones in the device 10) detects a sound, and this is passed to an initial processing block 60. The microphone 12 is capable of detecting audible sounds and sounds in the ultrasound range. As used herein, the term “ultrasound” (and “ultrasonic”) refers to sounds in the upper part of the audible frequency range, and above the audible frequency range. Thus, the term “ultrasound” (and “ultrasonic”) refers to sounds at frequencies above about 15 kHz or above about 20 kHz.

A pre-processing module 602 may for example include an analog-to-digital converter, for converting signals received from an analog microphone into digital form, and may also include a buffer, for storing signals. The analog-to-digital conversion involves sampling the received signal at a sampling rate. The sampling rate is preferably be chosen to be high enough that any frequency components of interest are retained in the digital signal. For example, as described in more detail below, some embodiments of the disclosure involve estimating and/or measuring ultrasonic components of the received signal, for example in the region of 20-30 kHz. As is well known from the Nyquist sampling theorem, the sampling rate of a digital signal need to be at least twice the highest frequency component of the signal. Thus, in order to properly sample a signal containing components at frequencies up to 30 kHz, the sampling rate should be at least 60 kHz.

The pre-processed received audio signal may optionally be passed to a voice activity detection (VAD) module 604 configured to detect whether speech is present in the received audio signal. The VAD module 604 may make a determination concerning the presence of speech in any manner known in the art. On detection of speech, the VAD module 604 may output a flag to a spectrum extraction module 606. In alternative embodiments, it may be assumed that the received audio signal contains speech. In which case, the VAD module 604 may be omitted and the pre-processed received audio signal may be passed directly to the spectrum extraction module 606 from the pre-processing module 602.

The audio signal representing speech may also be passed to the spectrum extraction module 606. The spectrum extraction module 606 may be configured to obtain a spectrum of the received audio signal. In some examples, the spectrum extraction module 606 may be configured to obtain a power spectrum of the received audio signal, while, in some other examples, the spectrum extraction module 606 may be configured to obtain an energy spectrum of the received audio signal.

In some examples, where the signal provided to the spectrum extraction module 606 is in the analog domain, the spectrum extraction module 606 may be configured to perform a fast Fourier transform on the received audio signal. The result of the fast Fourier transform is an indication of the power or energy present in the signal at different frequencies.

In another example, the spectrum extraction module 606 may be configured to apply one or more bandpass filters to the received audio signal representing speech. Each bandpass filter may only allow signals within a particular frequency band of the received audio signal to pass through.

Thus, the spectrum extraction module 606 may be configured to obtain information about the power and/or energy of various sub-bands of the received audio signal. In particular, these sub-bands may be in the audible range, for example between around 10 or 100 Hz to around 15 kHz or 20 kHz. In some embodiments, the ultrasonic estimation module 608 may implement a band-limited energy or power detector configured to detect an energy level or a power level in the one or more sub-bands.

In some embodiments, weights may be applied to the or each bandpass filtered signal. For example, frequencies that correspond to human loudness perception may be given more weight, such as frequencies below 20 kHz. In some embodiments, weighting may be applied to reduce sensitivity to differences in sound production between different cohorts of the population. Examples include differences between adult males and adult female, and between adults and children. For example, the fundamental frequencies of male and female voice tend to differ, and the fundamental frequencies of adult and child voice tend to differ. Such fundamental frequencies all tend to fall below around 200 Hz. As such, certain frequencies may be underweighted, such as frequencies below 200 Hz, to reduce sensitivity to such differences. In some embodiments, a roll-off weighting may be applied, such as to frequencies in the range of approximately 8 kHz and 20 kHz. In some embodiments, sub-bands which do not tend to carry the bulk of speech power may be de-emphasized by weighting.

Processing by the spectrum extraction module 606 may be performed in dependence of the received voice flag from the VAD module 604 (if provided). For example, the spectrum extraction module 606 may by triggered by received of the voice flag indicating that the audio signal received from the pre-processing module 602 comprises speech.

The spectrum information extracted by the spectrum extraction module 606 may be passed to an ultrasonic estimation module 608 configured to estimate one or more characteristics of ultrasonic content in the received audio signal. Such characteristics may include, for example, an estimated power level or energy level of an ultrasonic component of the received audio signal.

Ultrasonic estimation may be performed based on the spectrum information. For example, a characteristic of the audible passband, such as a power or an energy of an audible passband of the received audio signal, may be used to estimate a corresponding characteristic of an ultrasonic passband, such as an expected power or energy in the ultrasonic passband of the received audio signal. As noted above, an advantage of this process is that the ultrasonic content of the received audio signal need not be analysed itself.

In some embodiment, the ultrasonic estimation module 608 may compare the spectrum information received from the spectrum extraction module 606 to a model 610 of live and/or replayed speech. The model may be a model generated from live speech of a user of the personal audio device 10. Additionally, or alternatively, the model may be generated from live speech of a cohort of the general public.

The model may be generated using (optionally recurrent) neural network prediction. For example, a neural network may be trained with inputs relating to user' voice. The trained neural network may then be used to predict the expected signal characteristic based on the measured signal characteristics. Implementations of neural networks are known in the art and so will not be described in detail here.

Whilst the noise floor NF is shown in FIGS. 4A, 4B, 5A and 5B as being the same across all frequencies (i.e., having a flat frequency spectrum), it will be appreciated that in practice the noise floor of the system in which the microphone 12 is incorporate will likely not have a flat frequency spectrum. Likewise, the difference in power or energy in various sub-bands of audible content vs ultrasonic content in the received audio signal will differ. This is evidenced by FIGS. 4A, 4B, 5A and 5B, which illustrate the variation in magnitude of the received audio signal across the audible frequency spectrum.

In view of this, in some embodiments, the ratio of audible sound energy or level to ultrasonic sound energy or level may be modelled as a distribution with respect to frequency. In some embodiment, parametric modelling may be used. Such a model 608 may be provided as an input to the ultrasonic estimation module 610.

In some embodiments, the one or more characteristics of the ultrasonic content may be estimated using (optionally recurrent) neural network prediction. For example, a neural network may be trained with inputs relating to the spectrum information of multiple audio signals containing speech (e.g., live speech and/or replayed speech). The trained neural network may then be used to predict the ultrasonic content of the received audio signal based on the spectrum information extracted by the spectrum extraction module 604. Implementations of neural networks are known in the art and so will not be described in detail here.

The ultrasonic estimation module 601 may then output a result U of the ultrasonic estimation to a decision module 612. The decision module 612 may output a decision signal D regarding whether the received audio signal is suitable for use in liveness detection.

In some embodiments, the decision module 612 may determine that the received audio signal comprises the necessary ultrasonic content for liveness detection if the estimated ultrasonic characteristic(s) (estimated by the ultrasonic estimation module 608) exceeds a predetermined threshold.

In some embodiments, the decision module 612 may determine a score for the received audio signal based on the estimated ultrasonic characteristic(s). The determined score may be higher for higher values of the estimated ultrasonic characteristic(s). For example, an estimated ultrasonic characteristic may be ultrasonic power in one or more ultrasonic frequency bands. The determined score may be dependent on the value of the estimated ultrasonic power in the one or more ultrasonic frequency bands.

The decision signal D may comprise be a binary indication (i.e., that the received audio signal is or is not suitable for liveness detection). Additionally, or alternatively, the decision module 612 may determine a likelihood that the received audio signal is suitable for liveness detection and output that likelihood as the decision signal D. Additionally, or alternatively, the decision module 612 may determine both a likelihood that the received audio signal is suitable for liveness detection and a likelihood that the received audio signal is not suitable for liveness detection. The decision module 612 may then make a determination that the received audio signal is suitable for liveness detection by comparing the likelihoods. For example, if the likelihood that the received audio signal is suitable for liveness detection is greater than the likelihood that the received audio signal is not suitable for liveness detection, then the decision signal D may be a binary indication that the received audio signal is suitable for liveness detection. Conversely, if the likelihood that the received audio signal is suitable for liveness detection is less than the likelihood that the received audio signal is not suitable for liveness detection, then the decision signal D may be a binary indication that the received audio signal is not suitable for liveness detection.

In another example, if the likelihood that the received audio signal is suitable for liveness detection exceeds the likelihood that the received audio signal is not suitable for liveness detection by a predetermined threshold, then the decision signal D may indicate that the received audio signal is suitable for liveness detection. Conversely, if the likelihood that the received audio signal is not suitable for liveness detection exceeds the likelihood that the received audio signal is suitable for liveness detection by a predetermined threshold, then the decision signal D may indicate that the received audio signal is not suitable for liveness detection.

In yet another example, the decision module 602 may determine a ratio of the likelihood that the received audio signal is not suitable for liveness detection to the likelihood that the received audio signal is not suitable for liveness detection (or vice versa). If the ratio exceeds a threshold, then decision signal D may indicate that the microphone signal is suitable for liveness detection.

In some embodiments, the decision signal D output from the signal suitability module 600 may be used to trigger operation of one or more other modules or components.

FIG. 7 illustrates an example of such a scenario. The signal suitability module 600 outputs the decision signal D to an ultrasonic (US) liveness detection module 700. The signal suitability module 600 may also output the pre-processed audio signal P from the pre-processing module 602 to the US liveness detection module 700. The US liveness detection module 700 is configured to determine whether a received audio signal comprises live speech based on a measurement of an ultrasonic component of the received audio signal. Operation of the US liveness detection module 700 may be relatively more power intensive than operation of the signal suitability module 600. Operation of the US liveness detection module 700 may be triggered by a value of the decision signal D. For example, where the decision signal D is a binary output indicating that the received audio signal is suitable for liveness detection, the US liveness detection module 700 may be triggered to perform US liveness detection on the received audio signal. For example, where the decision signal D is a binary output indicating that the received audio signal is not suitable for liveness detection, the US liveness detection module 700 may not be triggered to perform US liveness detection on the received audio signal. In which case, the US liveness detection module 700 may be placed or maintained in a standby mode.

As is conventional, the signal may be divided into frames, for example of 10-100 ms duration. The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high-speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general-purpose processor or the like. A module may itself comprise other modules or functional units. A module may be provided by multiple components or sub-modules which need not be co-located and could be provided on different integrated circuits and/or running on different processors.

Embodiments may be implemented in a host device, especially a portable and/or battery powered host device such as a mobile computing device for example a laptop or tablet computer, a games console, a remote-control device, a home automation controller, or a domestic appliance including a domestic temperature or lighting control system, a toy, a machine such as a robot, an audio player, a video player, or a mobile telephone for example a smartphone.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. A method of detecting a suitability of a signal for live speech detection, the method comprising:
receiving the signal containing speech from a transducer;
measuring a signal characteristic of an audible component of the received signal;
estimating an expected signal characteristic of an ultrasonic component of the received signal based on the measured signal characteristic of the audible component; and
determining, based on the estimated expected signal characteristic, whether the ultrasonic component is suitable for detecting whether the speech is live speech.

2. The method of claim 1, wherein the measured signal characteristic and the expected signal characteristic are the same signal characteristic and comprise one of:
a power level; and
a sound pressure level.

3. The method of claim 1, further comprising:
on determining that the ultrasonic component is suitable, determining that the speech is live speech based on the ultrasonic component.

4. The method of claim 3, wherein determining that the speech is live speech comprises:
measuring a signal characteristic in the ultrasonic component of the received signal; and
determining whether the speech is live speech based on the measured signal characteristic.

5. The method of claim 4, wherein the measured signal characteristic in the ultrasonic component comprises power or sound pressure.

6. The method of claim 1, further comprising:
determining whether the received signal comprises speech.

7. The method of claim 1, wherein determining whether the ultrasonic component is suitable for detecting whether the speech is live speech comprises:
comparing the expected signal characteristic to an ultrasonic signal characteristic threshold.

8. The method of claim 1, wherein measuring the signal characteristic of the audible component comprises:
bandpass filtering the received audio signal to generate one or more bandpass filtered audio signals; and
measuring the signal characteristic in one or more of the one or more bandpass filtered audio signals.

9. The method of claim 8, wherein the one or more bandpass filtered audio signals comprise two or more bandpass filtered signals, wherein measuring the signal characteristic of the audible component further comprises:
applying weights to the measured signal characteristics in the two or more bandpass filtered signals, wherein the estimation of the expected signal characteristic in the ultrasonic component is based on one or more weighted bandpass filtered signals.

10. The method of claim 9, wherein the weights are applied to emphasize one or more of the bandpass filtered signals that correspond to human loudness perception.

11. The method of claim 9, wherein weights are applied to reduce sensitivity to differences in speech between different cohorts of the population.

12. The method of claim 1, wherein estimating the expected signal characteristic comprises providing the measured signal characteristic to a model of the expected signal characteristic for live speech.

13. The method of claim 12, wherein the model of the expected signal characteristic for live speech is generated using a speech model for a user of the transducer.

14. The method of claim 12, wherein the model of the expected signal characteristic for live speech is generated using a cohort of speakers.

15. A non-transitory storage medium having instructions thereon which, when executed by a processor, cause the processor to perform a method comprising:
receiving a signal containing speech from a transducer;
measuring a signal characteristic of an audible component of the received signal;
estimating an expected signal characteristic of an ultrasonic component of the received signal based on the measured signal characteristic of the audible component; and
determining, based on the estimated expected signal characteristic, whether the ultrasonic component is suitable for detecting whether the speech is live speech.

16. An apparatus for detecting a suitability of a signal for live speech detection, the method comprising:
an input for receiving a signal containing speech from a transducer;
one or more processors configured to:
measure a signal characteristic of an audible component of the received signal;
estimate an expected signal characteristic of an ultrasonic component of the received signal based on the measured signal characteristic of the audible component; and
determine, based on the estimated expected signal characteristic, whether the ultrasonic component is suitable for detecting whether the speech is live speech.

17. The apparatus of claim 16, wherein the measured signal characteristic and the expected signal characteristic are the same signal characteristic and comprise one of:
a power level; and
a sound pressure level.

18. The apparatus of claim 16, wherein the one or more processors are configured to:
on determining that the ultrasonic component is suitable, determine that the speech is live speech based on the ultrasonic component.

19. The apparatus of claim 16, wherein the one or more processors are configured to determine whether the ultrasonic component is suitable for detecting whether the speech is live speech by comparing the expected signal characteristic to an ultrasonic signal characteristic threshold.

20. An electronic device comprising the apparatus of claim 16.
